(19) United States
(12) Patent Application Publication
(10) Pub. No.: US 2018/0319934 A1
(43) Pub. Date: Nov. 8, 2018

(54) PRODUCTION PROCESS FOR DIGLYCIDYL-CAPPED POLYALKYLENE GLYCOLS WITH IN-SITU REMOVAL OF 1,4-DIOXANE

(71) Applicant: Dow Global Technologies LLC, Midland, MI (US)

(72) Inventors: Troy E. Knight, Missouri City, TX (US); Thomas C. Young, Lake Jackson, TX (US); Gerald W. Dare, Friendswood, TX (US); Hannah L. Crampton, Brenham, TX (US); Bruce D. Hook, Lake Jackson, TX (US); Pasquale Sirignano, Matera (IT); Daviele Vinci, Luzern (CH)

(73) Assignee: Dow Global Technologies LLC, Midland, MI (US)

(21) Appl. No.: 15/770,779

(22) PCT Filed: Oct. 19, 2016
(86) PCT No.: PCT/US2016/057674

§ 371 Date: Apr. 25, 2018

Related U.S. Application Data
(60) Provisional application No. 62/247,419, filed on Oct. 28, 2015.

(51) Int. Cl. C08G 65/24; C08G 65/12; C08G 65/46

(52) U.S. Cl. CPC C08G 65/24; B01J 27/135; C08G 65/46; C08G 65/12

(57) ABSTRACT

Produce diglycidyl-capped polyalkylene glycol by (a) providing epihalohydrin, a polyalkylene glycol that contains and ethylene oxide component and a Lewis acid; (b) coupling the epihalohydrin to the polyalkylene glycol using the Lewis acid as a catalyst to produce a coupling product; (c) stripping 1,4-dioxane from the coupling product; and (d) epoxidation of the coupling product by addition of a base to form diglycidyl-capped polyalkylene glycol in an organic phase.

### BACKGROUND OF THE INVENTION

### Field of the Invention

The present invention relates to a process for making diglycidyl-capped polyalkylene glycols.

### Introduction

A common process for manufacturing diglycidyl-capped polyalkylene glycols requires two steps: epihalohydrin (epi) coupling to a polyalkylene glycol followed by epoxidation. There is a challenge in the process when the polyalkylene glycol contains ethylene oxide components because 1,4-dioxane is then typically produced as a side-product during the initial epi coupling step. 1,4-dioxane is miscible with both aqueous and organic phases. Therefore, 1,4-dioxane becomes dispersed in both the aqueous and organic phases in the epoxidation step. Disposing of the aqueous phase at the end of the reaction becomes costly due to the presence of 1,4-dioxane, making the manufacturing process undesirably expensive. Moreover, recycling of the organic solvent becomes problematic because it is contaminated with 1,4-dioxane, which builds up if not removed.

It is desirable to identify a way to minimize contamination of water with 1,4-dioxane during the epoxidation step in the manufacture of diglycidyl-capped polyalkylene glycols that contain ethylene oxide components so as to minimize 1,4-dioxane in waste water.

### BRIEF SUMMARY OF THE INVENTION

The present invention offers a process improvement that minimizes contamination of water with 1,4-dioxane during the epoxidation step in the manufacture of diglycidyl-capped polyalkylene glycols that contain ethylene oxide and thereby simplifies challenges with having 1,4-dioxane in waste water after the manufacture of diglycidyl-capped polyalkylene glycols.

Moreover, it has been discovered that the present invention solves another problem that was discovered during the course of developing this invention. It was discovered that the presence of 1,4-dioxane inhibits formation of targeted diglycidyl-capped polyalkylene glycol products during the epoxidation step. The present invention further solves the newly discovered problem of unnecessarily low yield of product by removing 1,4-dioxane prior to the epoxidation step.

It has further been discovered that by removing 1,4-dioxane prior to epoxidation the final product has similar or even less color than if the 1,4-dioxane was left in through the epoxidation step.

The present invention is a result of discovering that stripping 1,4-dioxane from the reaction products of the epi coupling step prior to the epoxidation step resulted in benefits such as reduction in 1,4-dioxane disposal complications due to 1,4-dioxane in waste water, ability to recycle solvent in the reaction without 1,4-dioxane contamination and, surprisingly, higher yields of diglycidyl-capped polyalkylene glycols in the epoxidation step than achieved when 1,4-dioxane was present and similar final color of product.

In a first aspect, the present invention is a process comprising the steps of: (a) providing epihalohydrin, a polyalkylene glycol that contains and ethylene oxide component and a Lewis acid; (b) coupling the epihalohydrin to the polyalkylene glycol using the Lewis acid as a catalyst to produce a coupling product; (c) stripping 1,4-dioxane from the coupling product; and (d) epoxidation of the coupling product by addition of a base to form diglycidyl-capped polyalkylene glycol in an organic phase.

The process of the present invention is useful for preparing diglycidyl capped polyalkylene glycols.

### DETAILED DESCRIPTION OF THE INVENTION

“And/or” means “and, or alternatively”. All ranges include endpoints unless otherwise stated.

Test methods refer to the most recent test method as of the priority date of this document unless a date is indicated with the test method number as a hyphenated two digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standardizations.

The present invention comprises coupling of epihalohydrin to a polyalkylene glycol (PAG) that contains an ethylene oxide component using a Lewis acid catalyst in an absence of water to produce a coupling product.

The epihalohydrin can, in the broadest scope of the present invention, comprise any halogen. Examples of suitable epihalohydrins include any one or any combination of more than one selected from a group consisting of epichlorohydrin, epibromohydrin, and methylepichlorohydrin. Desirably, the epihalohydrin is epichlorohydrin.

The PAG has a structure of Structure (I):

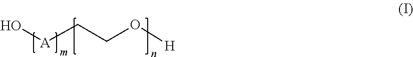

where A is selected from ethylene oxide components (—CH₂CH₂O—), 1,2-propylene oxide components (—CH(CH₃)CH₂O—), 1,2-butylene oxide components (—CH(CH₂CH₃)CH₂O—), and any random or block combinations thereof; m is a number that is zero or greater with an upper limit that provides at least 25 mole-percent ethylene oxide components in the PAG, desirably m is no more than 3n; n is a number that is one or more, preferably two or more, more preferably three or more and can be five or more, ten or more, 12 or more 13 or more, 14 or more, 15 or more, 16 or more, 17 or more 18 or more, 19 or more and even 20 or more while at the same time is typically 30 or less, and can be 25 or less, 20 or less, 19 or less, 18 or less, 17 or less, 16 or less, 15 or less, and even 14 or less ore 13 or less. In one desirably embodiment, m is zero and n is in a range of 12 to 14, and more preferably is in a range of 13 to 14. The PAG can be polyethylene glycol. Notably, PAGs often are an oligomeric mixture of molecules with slightly different m and n values. The m and n values referred to herein are averages for a given PAG sample material.

Desirably, the PAG has a molecular weight of 100 grams per mole (g/mol) or more, preferably 150 g/mol or more and can have a molecular weight of 200 g/mol or more, 250 g/mol or more, 300 g/mol or more, 400 g/mol or more, 500 g/mol or more, 600 g/mol or more, 700 g/mol or more, 800 g/mol or more, 900 g/mol or more, 1000 g/mol or more 1250 g/mol or more 1500 g/mol or more and even 1750 g/mol or more while at the same time is generally 2000 g/mol or less, and can be 1750 g/mol or less, 1500 g/mol or less, 1250 g/mol or less, 1000 g/mol or less and even 750 g/mol or less. Determine molecular weight of the PAG using the formula:

Molecular Weight=56.1*1000*functionality/OH#

where functionality is the number of —OH groups per molecule and OH# is the —OH content in milligrams potassium hydroxide per gram of material as determined by ASTM D4274.

The Lewis acid for use in the coupling reaction can, in the broadest cope of the present invention, be any Lewis acid. Particularly desirable Lewis acids for use in the coupling reaction include any one or any combination of more than one selected from a group consisting of boron trifluoride (for example, boron trifluoride diethyl etherate, boron trifluoride dimethyl etherate), stannic chloride, aluminum chloride, zinc trichloride and ferric chloride.

Optionally, but desirably, deactivate the Lewis acid after the coupling reaction is complete and before proceeding to strip 1,4-dioxane from the reaction products. Deactivate the Lewis acid by adding, for example, one or more than one Lewis base and/or Bronsted base. Examples of suitable Lewis bases include phosphate salts, acetate salts, and sulfonate salts. Examples of suitable Bronsted bases include alkali metal or alkaline earth hydroxides or carbonates. Typically, add the base at a 1:1 molar ratio or higher relative to the Lewis acid concentration in order to fully neutralize the Lewis acid.

It is generally desirably to conduct the coupling reaction with as little water present as possible. Water can interfere with the catalyst and can encourage formation of undesirable side reactions. While water can be present during the coupling reaction, it is generally desirably for the water concentration to be five weight-percent (wt %) or less, preferably four wt % or less, more preferably three wt % or less yet more preferably two wt % or less, even more preferably one wt % or less, 0.5 wt % or less, or 0.1 wt % or less, based on total weight of polyalkylene glycol and Lewis acid. The coupling reaction can be run without a measurable amount of water. Determine the amount of water in the reaction mixture by Karl-Fisher titration.

The coupling reaction can be done by forming a mixture of the PAG and Lewis acid catalyst, adding the epihalohydrin to the mixture, and allowing the mixture to react. The coupling reaction can be conducted in a solvent. The mole ratio of epihalohydrin to hydroxyl groups on the PAG is desirably 0.8:1 or more, preferably 1:1 or more and more preferably 1.05:1 or more while at the same time is generally 2:1 or less, preferably 1.5:1 or less and more preferably 1.4:1 or less. The temperature of the mixture in the coupling reaction is generally zero degrees Celsius (° C.) or more, preferably 20° C. or more and more preferably 40° C. or more while at the same time is generally 100° C. or less, preferably 90° C. or less and more preferably 80° C. or less. The coupling reaction can be at one atmosphere pressure, greater than one atmosphere pressure or below one atmosphere of pressure. Generally, the coupling reaction is done at a pressure of 10 kilo pascals (kPa) or more, preferably 50 kPa or more and at the same time 1000 kPa or less, preferably 500 kPa or less.

A particular challenge with the coupling reaction of epihalohydrin with a PAG containing an ethylene oxide component is that 1,4-dioxane tends to be produced as an undesirable side product. However, because the coupling reaction is run in an absence of water the 1,4-dioxane by-product is only in an organic phase rather that distributed between both aqueous and organic phases. An object of the present invention is to avoid having 1,4-dioxane dispersed in both organic and aqueous phases. Another object of the present invention is to avoid carrying 1,4-dioxane through from the coupling reaction into the epoxidation reaction. 1,4-dioxane has been found to lower both the quality and yield of the product of the epoxidation reaction if left in for the epoxidation reaction.

Strip 1,4-dioxane from the coupling product. Examples of suitable methods for stripping of 1,4-dioxane from the coupling product include any of the following or combinations of the following: bulk stripping, falling film evaporation, agitated thin film evaporation, column stripping and stripping by distillation. It is desirable, though not necessary, to avoid adding water to the coupling product during the stripping step (that is, to strip 1,4-dioxane without adding water to the coupling product). As in the coupling reaction, it is desirable to avoid forming both aqueous and organic phases for the 1,4-dioxane to become dispersed in. However, the objective of the stripping step is to remove 1,4-dioxane prior to the epoxidation step so there is minimal 1,4-dioxane after the epoxidation step. Therefore, stripping with water is acceptable at this point.

After stripping 1,4-dioxane from the coupling product, epoxidize the coupling product by adding a base to the coupling product to form a diglycidyl capped polyalkylene glycol. Desirably, the base is a hydroxide such as any one or any combination of more than one base selected from a group consisting of alkali metal hydroxides and alkaline earth metal hydroxides. Suitable bases include any one or any more than one selected from a group consisting of sodium hydroxide, potassium hydroxide, and calcium hydroxide. The mole ratio of base to hydroxyl groups on the PAG is desirably 0.8:1 or more, preferably 1:1 or more and more preferably 1.01:1 or more while at the same time is desirably 2:1 or less, preferably 1.5:1 or less and more preferably 1.3:1 or less. The base causes a dehydrohalogenation of the coupling product and generates a diglycidyl-capped polyalkylene glycol product and a halide salt by-product. Separate the by-product salt from the diglycidyl-capped polyalkylene product. Desirably, conduct the epoxidation reaction in an organic solvent that does not react with the coupling product or base.

The epoxidation reaction converts the coupling product into a diglycidyl-capped polyalkylene glycol. Desirably, remove halide salts from the diglycidyl-capped polyalkylene glycol by rinsing, preferably repeatedly, the reaction products of the epoxidation reaction with water and separating the salt-containing aqueous phase from the diglycidyl-capped polyalkylene glycol containing organic phase.

If so desired, the diglycidyl-capped polyalkylene glycol can be neutralized by adding carbon dioxide, a weak inorganic acid, a weak organic acid or a dilute mixture of a strong inorganic acid to the organic phase containing the diglycidyl-capped polyalkylene glycol.

It is generally further desirable to isolate the diglycidyl-capped polyalkylene glycol resin from other organic components, which can be accomplished by, for example, evaporation or stripping in some other way the organic components away from the diglycidyl-capped polyalkylene glycol resin.

The process of the present invention avoids carrying 1,4-dioxane through to the epoxidation reaction and avoids having an aqueous phase contaminated with 1,4-dioxane in the reaction products. The product resulting from the present invention also has similar color as product obtained without removing 1,4-dioxane prior to epoxidation. Measure color by ASTM D5386. The present invention further demonstrates greater ring closure to the epoxide during the epoxidation step, resulting in greater final yield of diglycidyl-capped polyalkylene glycol than the reaction where 1,4-dioxane is left in during epoxidation.

### EXAMPLES

### Comparative Example A—Leaving 1,4-Dioxane in Through Epoxidation

Under a blanket to nitrogen, charge 755.1 grams (g) of PEG 600 into a two-liter glass reactor. PEG 600 is a polyethylene glycol having an average number average molecular weight of 600 grams per mole. PEG 600 has a structure of Structure (I) where n is between 13 and 14. Heat the reactor to 60 degrees Celsius (° C.) while agitating the contents. Charge to the reactor 0.926 g of boron trifluoride diethyl etherate. Introduce an initial charge of 25.5 g epichlorohydrin into the reactor, which results in an exotherm. Once the exotherm subsides, maintain a 60-63° C. reactor temperature while slowly feeding 293.9 g of epichlorohydrin. Upon full addition of epichlorohydrin, maintain the reactor at 60-63° C. for one hour. The resulting reactor contents contains more than ten wt % 1,4-dioxane relative to total reactor content weight.

Transfer the resulting reactor contents containing chlorohydrin intermediate resin to another nitrogen-purged two-liter glass reactor. Begin agitation and introduce 603.8 g of toluene. Under a nitrogen sweep, feed 72.9 g of deionized water and 4.15 g of 60% benzyltrimethyl ammonium chloride (BTMAC) solution to the reactor. Heat the reactor to 50° C. Maintain the reactor in a temperature range of 48-52° C. while adding 121.1 g of 50% caustic soda solution over the course of 30 minutes, after which maintain the temperature for another 80 minutes. Add 146.5 g deionized water to the reactor while maintaining temperature. Transfer the two-phase mixture to a two-liter separatory funnel and remove the lower aqueous phase.

Charge the organic layer to yet another two-liter glass reactor. Under a nitrogen sweep, charge 72.9 g of deionized water and 4.15 g of a 60% BTMAC solution to the reactor. Heat the reactor to 50° C. Maintain the reactor in a temperature range of 48-52° C. while adding 121.1 g of 50% caustic soda solution over the course of 30 minutes, after which maintain the temperature for another 80 minutes. Add 62.2 g of deionized water to the reactor while maintaining temperature. Transfer the two-phase mixture to a two-liter separatory funnel and remove the lower aqueous phase.

Charge the organic layer to yet another nitrogen purged two-liter glass reactor, heat to 50° C. Maintain the reactor in a temperature range of 48-52° C. while adding 13.3 g of 50% caustic soda solution. Add 60.89 g of deionized water while maintaining a temperature in a range of 48-52° C. Transfer the two-phase mixture to a two-liter separatory funnel and remove the lower aqueous layer.

Charge the organic layer to a nitrogen swept two-liter glass reactor charged with 197.9 g of toluene and heat to 78-82° C. Maintain the temperature and nitrogen sweep while adding 61.7 g deionized water and then 2.03 g monosodium phosphate and then stir for 30 minutes. After 30 minutes stop stirring and allow phases to separate. Remove the lower aqueous phase. Distill off the solvent using heat and vacuum until boil-up is lost. Remove remaining solvent by steam sparge cycles.

The resulting diglycidyl-capped polyethylene glycol has an epoxy equivalent weight of 333 grams per gram equivalents, a hydrolyzable chloride content of 360 weight parts per million weight parts product. The APHA color of the product is 54 as determined according to ASTM D1209. The yield of epoxide end capped product is 71.4% with alcohol end capped product being 2.0%, ring opened epi being 26.5% and 0.41 weight-parts per million 1,4-dioxane.

### Example 1—Removing 1,4-Dioxane Prior to Epoxidation

Charge into a two-liter glass reactor 981.5 g of PEG600 under a blanket of nitrogen. Heat the reactor to 60° C. while agitating the contents. Charge 1.22 g of boron trifluoride-diethyl etherate. Introduce an initial charge of 33.3 g epichlorohydrin, which results in an exotherm. Once the exotherm subsides maintain a reactor temperature of 60-63° C. while slowly adding 381.8 g of epichlorohydrin. Maintain at temperature for an hour after addition of all epichlorohydrin. The resulting reactor contents contains more than ten wt % 1,4-dioxane relative to total reactor content weight.

Distill off 1,4-dioxane by-product under reduced pressure at a temperature of 70-75° C. until boil-up is lost. Remove the balance of 1,4-dioxane by water sparge cycles or any other standard stripping technique (including water-free techniques) until the concentration of 1,4-dioxane is less than two weight parts per million weight parts reaction product.

Transfer the reaction product to a nitrogen purged two-liter glass reactor, begin agitation and add 667.6 g toluene. Under a nitrogen sweep, add 80.6 g deionized water and 4.58 g of 60% BTMAC solution. Heat the reactor to 50° C. and maintain in a temperature range of 48-52° C. while adding 134.0 g of a 50% caustic soda solution over 30 minutes. Hold at temperature for 80 more minutes. Add 162.2 g of deionized water to the reactor while maintaining temperature. Transfer the two-phase solution to a two-liter separatory funnel and remove the lower aqueous layer.

Transfer the organic layer to a nitrogen purged two-liter glass reactor. Under a nitrogen sweep add 80.6 g deionized water and 4.58 g of a 60% BTMAC solution. Heat the reactor to 50° C. and maintain in a temperature range of 48-52° C. while adding 133.8 g of a 50% caustic soda solution over 30 minutes. Hold at temperature for 80 more minutes. Add 69.4 g of deionized water to the reactor while maintaining temperature. Transfer the two-phase solution to a two-liter separatory funnel and remove the lower aqueous layer.

Transfer the organic layer to a nitrogen purged two-liter glass reactor charged with 204.7 g of toluene and heat to 78-82° C. Add 63.2 g of deionized water and then 2.13 g of monosodium phosphate. Stir for 30 minutes. Allow the phases to separate and remove the lower aqueous layer. Distill off solvent using heat and vacuum until boil-up is lost. Remove remaining solvent by steam sparge cycles.

The resulting diglycidyl-capped polyethylene glycol has an epoxy equivalent weight of 324 grams per gram equivalents, a hydrolyzable chloride content of 620 weight parts per million weight parts product. The APHA color of the product is 60 as determined by ASTM D1209. The APHA color measurement of 60 is indistinguishable from the APHA color measurement of 54 of Comparative Example A. The yield of epoxide end capped product is 76.1% with alcohol end capped product being 2.7%, ring opened epi being 21.2% and 0.11 weight parts per million of 1,4-dioxane.

The Example process produced product with higher yield (76.1% versus 71.4%) and similar APHA color (60 versus 54). The Example process also resulted in nearly ¼^{th} the amount of 1,4-dioxane in the final product.

1. A process comprising the steps of:
(a) providing epihalohydrin, a polyalkylene glycol that contains an ethylene oxide component and a Lewis acid;
(b) coupling the epihalohydrin to the polyalkylene glycol using the Lewis acid as a catalyst to produce a coupling product;
(c) stripping 1,4-dioxane from the coupling product; and
(d) epoxidation of the coupling product by addition of a base to form diglycidyl-capped polyalkylene glycol in an organic phase.

2. The process of claim 1, wherein the Lewis acid is selected from a group consisting of aluminum trichloride, boron trifluoride, zinc trichloride, ferric chloride, and stannic chloride.

3. The process of claim 1, wherein the polyalkylene glycol is polyethylene glycol.

4. The process of claim 1, wherein the epihalohydrin is epichlorohydrin.

5. The process of claim 1, wherein the base comprises hydroxide.

6. The process of claim 1, wherein the process further includes deactivating the Lewis acid catalyst.

7. The process of claim 1, wherein the process further comprises rinsing the organic phase with water and separating off the resulting water phase from the organic phase.

8. The process of claim 1, wherein the concentration of water present during the coupling step (b) is one weight-percent or less based on total weight of polyalkylene glycol and Lewis acid.

9. The process of claim 1, wherein the stripping step (c) is done without adding water to the coupling product.
